(19) United States
(12) Patent Application Publication
(10) Pub. No.: US 2017/0104224 A1
(43) Pub. Date: Apr. 13, 2017

(54) MICRO BATTERY, AND METHOD FOR PRODUCING A MICRO BATTERY

(71) Applicant: Fraunhofer-Gesellschaft zur Foerderung der angewandten Forschung e.V., Muenchen (DE)

(72) Inventor: Robert Hahn, Berlin (DE)

(21) Appl. No.: 15/311,181

(22) PCT Filed: May 13, 2015
(86) PCT No.: PCT/EP2015/060619

§ 371 Date: Nov. 14, 2016

(30) Foreign Application Priority Data
May 15, 2014 (DE) 10 2014 209 263.9

(51) Int. Cl. H01M 6/40

(52) U.S. Cl. CPC H01M 6/40; H01M 2220/30

(57) ABSTRACT

A method for manufacturing a microbattery including forming a layered structure with a first metal layer, a second metal layer, and an insulator layer; structuring at least one of the second metal layer and the insulator layer for exposing at least a first electrode contact region of the first metal layer; forming a first electrode that electrically contacts the first metal layer and projects beyond an upper side of the second metal layer; forming a separator structure that encloses or enwalls the first electrode and extends from the upper side of the first metal layer at least up to the upper side of the second metal layer; forming at least one second electrode on the second metal layer; and forming an ion conductor that contacts the first electrode and the second electrode so ions can travel between the first electrode and the second electrode.

### CROSS-REFERENCE TO RELATED APPLICATION

This application is a national phase application of PCT Application No. PCT/EP2015/060619, internationally filed May 13, 2015, which claims priority to German Application 10 2014 209 263.9, filed May 15, 2014, all of which are herein incorporated by reference in their entirety.

### TECHNICAL FIELD

The disclosure relates to a microbattery and to a method for manufacturing a microbattery.

### BACKGROUND

In the course of increasing miniaturisation in many fields of technology, there exists a constantly increasing demand for as small as possible and as thin and flexible as possible batteries. Such batteries are applied for example in energy-autarkic microsystems, such as miniaturised radio sensors, active RFIF tags, medical implants or smartcards. The batteries should have an as large as possible energy density and with regard to their dimensions should be adaptable to the respective application. It is advantageous to arrange as many battery cells as possible on a common substrate, for reducing the manufacturing costs.

These demands may be met by so-called 3D batteries. With this battery type, the negative and the positive electrode are not stacked over one another, but are arranged in a plane in the form of strips, cuboids or columns, which lie next to one another, and are surrounded by an electrolyte. Different metals, such as copper and aluminium for example must be used as current collectors for the plus pole and minus pole of the battery, for certain electrode materials. The depositing and structuring of the metals serving as current collectors, on a common insulating substrate however until now has required much effort and is expensive.

### SUMMARY

A 3D microbattery, with which each electrode has an individual current collector, is described in the document WO 2009/106365 A1. The current collectors are attached onto the same insulating substrate. The contacts can either be led onto the surface of the substrate, or they can be led onto the lower side of the substrate with the help of vias. However, expensive processes such as vacuum deposition, sputtering, photolithography or galvanic methods are necessary for the manufacture of such contacts.

The document US 2006/0154141 A1 likewise describes a 3D microbattery. Current collectors for the electrodes are deposited on an insulating substrate. An electrolyte which slightly overlaps the current collectors is subsequently deposited. The electrodes are created in openings of this electrolyte layer, wherein an individual current collector is assigned to each electrode. The electrodes are arranged in a strip-like or chequered manner. Here too, the manufacture can only be carried out whist applying complicated and cost-intensive methods.

It is therefore the object of the present disclosure, to develop a method for manufacturing 3D micro batteries, with which one can largely make do without cost-intensive vacuum technologies. The 3D micro batteries which are manufactured with this method should be as small, thin and as mechanically flexible as possible and have an as large as possible energy density.

What is thus suggested is a method for manufacturing a microbattery, comprising the steps:
forming a layered structure with a first metal layer for forming a first current collector, with a second metal layer for forming a second current collectors and with an insulator layer which is arranged between the first metal layer and the second metal layer, so that the insulator layer electrically insulates the first metal layer from the second metal layer;
regionally structuring the second metal layer and/or the insulator layer, for exposing at least a first a first electrode contact region of the first metal layer at an upper side of the first metal layer which faces the insulator layer;
forming at least one first electrode, in a manner such that the first electrode electrically contacts the first metal layer in each case in the exposed, first electrode contact region, and that the first electrode engages through the insulator layer and the second metal layer and projects beyond an upper side of the second metal layer which is away from the insulator layer:
forming at least one separator structure in a manner such that the separator structure in each case encloses or enwalls the first electrode and extends from the upper side of the first metal layer at least up to the upper side of the second metal layer, so that the separator structure insulates the first electrode from the second metal layer;
forming at least one second electrode on the second metal layer, so that the second electrode electrically contacts the second metal layer; and
forming an ion conductor in a manner such that the ion conductor contacts the first electrode and the second electrode, so that ions can travel via the ion conductor from the first electrode to the second electrode or from the second electrode to the first electrode.

A microbattery which is manufacturable with this method is also put forward. Such a microbattery comprises:
a layered structure with a first metal layer forming a first current collector, with a second metal layer forming a second current collector, and with a insulator layer which is arranged between the first metal layer and the second metal layer and which electrically insulates the first metal layer from the second metal layer;
at least one first electrode and at least one second electrode;
at least one separator structure; and
an ion conductor which contacts the first electrode and the second electrode, so that ions can travel via the ion conductor from the first electrode to the second electrode or from the second electrode to the first electrode;
wherein the first electrode electrically contacts the first metal layer at an upper side of the first metal layer which faces the insulator layer and wherein the first electrode engages through the insulator layer and through the second metal layer and projects beyond an upper side of the second metal layer which is away from the insulator layer;
the second electrode contacts the second metal layer, preferably at the upper side of the second metal layer; and
the separator structure encloses or enwalls the first electrode in a lateral manner, i.e. planes aligned parallel to the layer planes of the layered structure, and thereby extends from the upper side of the first metal layer at least up to the upper side of the second metal layer, so that the separator structure electrically insulates the first electrode from the second metal layer.

The microbattery is manufactured starting from a layered structure. This three-layered construction which serves as a substrate is manufacturable in a simple manner by way of known laminating and foil technologies. The microbattery manufactured in such a manner therefore has a particularly flat constructional shape, is extremely flexible and can be easily adapted to the geometry of miniaturised housings. The first metal layer serving as a first current collector and/or the second metal layer serving as a second current collector, as the case may be, can form at least a part of a housing of the battery. Material costs can be reduced by way of this, as well as the number of working steps necessary for manufacture. The structuring of the layered structure as well as the formation of the electrodes and of the separator structure can be carried out to a greater extent or completely, without the aid of costly vacuum technologies. The manufacturing process can therefore be considerably simplified and the manufacturing costs can be significantly reduced.

Typically, an upper side of the first metal layer is joined together with a lower side of the insulator layer and is in direct contact with this. An upper side of the insulator layer which is away from the first metal layer is usually joined together with a lower side of the second metal layer and is in direct contact with this. An upper side of the second metal layer which is away from the insulator layer, and a lower side of the first metal layer which is away from the insulator layer thus usually at the same time form an upper side and a lower side of the layered structure.

Here and hereinafter, a direction running perpendicularly to the layer planes of the layered structure is also called Z-direction. Accordingly, the layer planes of the layered structure are aligned parallel to an X-Y plane, wherein the X-axis, Y-axis and Z-axis span a right-handed Cartesian coordinate system. A thickness of the layered structure which is determined along the Z-direction can be less than 1 mm, preferably less that 0.6 mm, particularly preferably less that 0.2 mm. A thickness of the first metal layer and/or of the second metal layer can be less than 0.5 mm, less that 0.1 mm, less that 0.05 mm or less that 0.02 mm. A thickness of the insulator layer can be less than 0.05 mm, less than 0.01 mm or less than 0.005 mm. A microbattery which is based on such a thin, three-layered substrate is mechanically particularly flexible and can be integrated into an application system in a particular space-saving manner. Such an application system for example can be a radio sensor, an RFID tag, a medical implant or a smartcard.

The first metal layer and/or the second metal layer can be given by a metal foil. The insulator layer can be formed as an adhesive layer or as a layer of a thermoplastic plastic. In particular, the insulator layer can contain one of the following materials: Si₃N₄, SiO₂, Al₂O₃, a parylene, or a polyolefin, in particular polyethylene, polypropylene or cast polypropylene (CPP), polymethyl methacrylate (PMMA), an epoxy resin or a polyimide. The insulator layer can be deposited onto the first metal layer and/or onto the second metal layer for example by way of reactive vapour deposition or by way of chemical vapour deposition (CVD). The manufacture of the layered structure can also be carried out by way of laminating.

Each of the two metal layers can form or contact the plus pole or the minus pole of the microbattery. The first metal layer can be formed from aluminium. It then preferably forms the plus pole of the microbattery. The second metal layer can be formed from copper. It then preferably forms the minus pole of the microbattery.

The steps for manufacturing the microbattery which have been specified above do not necessarily have to be carried out in the specified temporal sequence. It can for example be advantageous to firstly form the separator structure after exposing the first electrode contact region on the upper side of the first metal layer, and only thereafter to plate or deposit the first electrode in the first electrode contact region, due to the fact that the separator in particular serves for separating and electrically insulating the first electrode from the second metal layer and/or from the second electrode. For example, in this manner one can prevent a short circuit between the first electrode and the second metal layer from occurring when forming the first electrode.

The regional structuring of the second metal layer at the upper side of the layered structure for exposing the first electrode contact region can be carried out by way of wet-etching, by way of laser ablation or by way of a mechanical method, in particular by way of drilling, milling, cutting or punching. The regional structuring of the insulator layer for exposing the first electrode contact region can be carried out by way of dry-etching, by way of laser ablation or likewise by way of a mechanical method, in particular thus by way of drilling, milling cutting or punching. Thus typically an opening is incorporated into the second metal layer and/or into the insulator layer, at the upper side of the layered structure, for exposing the first electrode contact region which is a part-region of the upper side of the first metal layer. This opening then extends from the upper side of the second metal layer through the second metal layer and through the insulator layer up to the upper side of the first metal layer. The first electrode contact region thus forms a base of the mentioned opening. The first electrode is usually deposited onto the first metal layer or plated on the first metal layer, in the first electrode contact region, from the upper side of the layered structure.

In some embodiments of the method for manufacturing the microbattery, the second metal layer and the insulator layer can firstly be joined together into a composite. This composite can then be subsequently joined together with the first metal layer for forming the layered structure. The second metal layer for example can be coated over the whole surface for forming the insulator layer on the lower side of the second metal layer. A through-hole can then be incorporated into the composite of the second metal layer and the insulator layer, for structuring the second metal layer and the insulator layer, which is to say for forming the previously mentioned opening in the second metal layer and the insulator layer. This can be effected by way of punching or drilling for example. If the composite of the second metal layer and the insulator layer are now joined together with the first metal layer, for example by way of laminating, for forming the layered structure, then the first electrode contact region on the upper side of the first metal layer is already exposed in the region of the through-hole after joining the composite together with the first metal layer. This is a particularly simple and inexpensive way and manner of structuring the second metal layer and the insulator layer, for exposing the first electrode contact region.

However, it is also conceivable not to coat the lower side of the second metal layer over the whole surface, but only to coat it regionally, for forming the insulator layer. For example, that region or those regions of the insulator layer, which would otherwise have to be structured for the later exposure of the first electrode contact region or of the first electrode contact regions, can be left out or exposed from the very beginning. A mask or a stencil can be used for this purpose, on coating the second metal layer for forming the insulator layer. In the composite of the second metal layer and the insulator layer, the insulator layer then comprises a corresponding hole or a corresponding through-hole. After the joining of the composite of the second metal layer and of the insulator layer, together with the first metal layer for forming the layered structure, it is then only the second metal layer which then yet needs to be structured for exposing the first electrode contact region or the first electrode contact regions, of the first metal layer. This can also entail a simplification of the manufacturing process.

The separator structure is preferably designed in a manner such that it radially completely encloses or enwalls the first electrode in a lateral manner, i.e. in planes directed parallel to the X-Y plane, so that the separator structure completely separates and insulates the first electrode from the second metal layer and/or from the second electrode. The separator structure can enclose or enwall the first electrode, e.g. in the manner of a tube section, wherein the tube cross section parallel to the X-Y plane can have an arbitrary shape. The separator structure preferably encloses the first electrode in each case in a radially complete manner, along the entire length of the first electrode which is determined along the Z-direction. The first electrode, the second electrode and the separator structure can therefore be designed in a manner such that the separator structure extends from the upper side of the first metal layer at least up to the upper end of the first electrode which is away from the first metal layer, preferably beyond the upper end of the first electrode, so that the first electrode and the second electrode are separated from one another along planes running parallel to the X-Y plane, by way of the separator structure. The separator structure for example can completely line a lateral wall of the previously mentioned opening in the second metal layer and in the insulator layer, by way of which opening the first electrode contact region is exposed.

For example, the separator structure can be formed by way of spray coating, electrophoresis, plasma polymerisation, laminating or screen printing. A further insulator layer can firstly be deposited for example, for forming the separator structure. The further insulator layer then usually completely lines the side walls of the opening in the second metal layer and the insulator layer. Typically, the further insulator layer also covers the first electrode contact region at the upper side of the first metal layer and/or the upper side of the second metal layer. The further insulator layer is then preferably again structured for the renewed exposure of the first electrode contact region and/or for exposing at least one second electrode contact region, at the upper side of the second metal layer. The further insulator layer can be structured for example by way of photolithography, by way of dry-etching or by way of laser ablation, for this purpose. The at least one second electrode contact region of the second metal layer on the upper side of the second metal layer serves for contacting the second metal layer by the second electrode.

In some embodiments of the method, the formation of the separator structure in particular can comprise the following steps:
depositing a temporary photoresist;
regionally removing the temporary photoresist by way of photolithography, for creating at least one hole in the temporary photoresist; and
depositing an ionically conductive separator mass in the hole, for forming the separator structure.

In some embodiments, the hole which is previously created in the photoresist is filled with the ionically conductive separator mass for forming the separator structure. The remaining photoresist is then typically removed in a next step. The ionically conductive separator mass, from which the separator structure is formed, for example can contain a binder with ceramic particles and/or particles of ionically conductive glasses. The separator structure can additionally be impregnated with a liquid electrolyte. The ionic conductivity of the separator structure can therefore be created or increased by way of the impregnation with the fluid electrolyte. In some embodiments, the ion conductor can be formed completely or at least partly by the separator structure, so that no further layer needs to be deposited onto the layered structure for forming the ion conductor. A thickness of the manufactured microbattery can be reduced by way of this.

The formation of the first electrode and/or of the second electrode can be carried out by way of sputtering, reactive vapour deposition, screen printing, stencil printing, dispensing or by way of a galvanic deposition process. The first metal layer and/or the second metal layer can be pre-treated before the formation of the electrodes, for improving the electrical contactability, preferably by way of wet-etching, dry-etching or by way of depositing a polymer layer to which graphite or soot particles have been added. The pre-treatment in particular is preferably carried out in the first electrode contact region on the upper side of the first metal layer and/or in the second electrode contact region on the upper side of the second metal layer, thus where the electrodes are deposited onto the metal layers.

A polymer ion conductor, a solid-body ion conductor, a gelifying liquid electrolyte or a porous or sponge-like structure impregnatable with a liquid electrolyte can be deposited for forming the ion conductor. A frame can be arranged on the second metal layer, before the depositing or plating of the liquid electrolyte, in order to prevent the liquid electrolyte from flowing away on depositing or plating a liquid electrolyte. The frame can be fastened to the second metal layer or be connected to the second metal layer, typically at the upper side of the second metal layer, for example by way of bonding, soldering or ultrasonic welding. The frame can be then be closed off with a cover after the depositing or plating of the liquid electrolyte. However, it is also conceivable for the frame and the cover to be designed in a single-part manner, wherein the liquid electrolyte is then filled through a closable opening in the cover.

The layered structure can be joined together with a plastic substrate having a greater thickness than the layered structure, so that the microbattery which is manufactured by way of the method suggested here has an as good as possible mechanical stability. The layered structure for example can be laminated onto the plastic substrate. The plastic substrate can be joined together with the layered structure, at the lower side of the layered structure, thus in particular at the lower side of the first metal layer, or at the upper side of the layered structure, thus in particular at the upper side of the second metal layer. If the layered structure and the plastic substrate are joined together such that the plastic substrate is arranged on the upper side of the layered structure, then usually the plastic substrate is also structured, for exposing the at least one first electrode contact region and for exposing the at least one second contact region. Narrow channels with a large aspect ratio can be easily incorporated into the plastic substrate for this. The aspect ratio thereby indicates the ratio between a depth of the channels incorporated into the plastic substrate and a lateral extension of the channels which is defined perpendicularly to the depth of these channels. The incorporation of the channels into the plastic substrate can be carried out by way of laser machining for example. A large-surfaced recess or deepening at the upper side of the plastic substrate which is away from the layered structure can also be created by way of die-casting, embossing or milling. Such a large-surfaced deepening or recess in the plastic substrate for example can serve for receiving the ion conductor. The ion conductor can therefore be arranged at least partly in the mentioned large-surfaced deepening.

The microbattery which is manufactured by way of the method described here typically comprises a multitude of first electrodes and second electrodes of the mentioned type. These for example can be arranged in parallel, in strips or in a chequered manner, next to one another in planes which are directed parallel to the X-Y plane. A first electrode contact region and a separator structure laterally surrounding the first electrode are then assigned to each first electrode of the microbattery. If the microbattery therefore has a multitude of first electrodes, then the microbattery has just as many separator structures which enclose or enwall the first electrode in the described way and manner in each case.

### BRIEF DESCRIPTION OF THE DRAWINGS

Embodiment examples of the disclosure are represented in the figures and are explained in more detail by way of the subsequent description. There are shown in:

FIG. 1 a layered structure with a first metal layer, a second metal layer and an insulator layer arranged between the first metal layer and the second metal layer, according to embodiments of the disclosure;

FIG. 2a, 2b in a temporal sequence, the regional structuring of the second metal layer and of the insulator layer of the layered structure of FIG. 1, for exposing first electrode contact regions at an upper side of the first metal layer, according to embodiments of the disclosure;

FIG. 3a, 3b starting from the structured, layered structure according to FIG. 2b, the formation of separator structures in edge regions of the first electrode contact regions, according to embodiments of the disclosure;

FIG. 4a, 4b starting from the arrangement according to FIG. 3b, the formation of first electrodes and second electrodes, as well as the formation of an ion conductor between the first electrodes and the second electrodes, according to embodiments of the disclosure;

FIG. 5a, 5b starting from the arrangement according to FIG. 2b, the formation of separator structures, according to embodiments of the disclosure;

FIGS. 6a to 6c starting from the arrangement according to FIG. 5b, the depositing of two first electrodes and a second electrode, the formation of the ion conductor between the first electrodes and the second electrode, and the closure of the thus manufactured microbattery by a housing closure, according to embodiments of the disclosure;

FIGS. 7a to 7d starting from the arrangement according to FIG. 2b, the formation of separator structures, as well as the deposition of two first electrodes and a second electrode, according to embodiments of the disclosure;

FIG. 8a, 8b starting from the arrangement according to FIG. 7d, the arranging of a frame for receiving a fluid electrolyte at the upper side of the layered structure as well as the filling of the frame with a liquid electrolyte for forming an ion conductor between the first electrode and the second electrode, according to embodiments of the disclosure;

FIGS. 8c to 8e the closure of the arrangement according to FIG. 8b with a cover and the sealing of the arrangement with a barrier layer, according to embodiments of the disclosure;

FIGS. 9a to 9c starting from the arrangement according to FIG. 7d, the arranging of a closed frame for receiving a liquid electrolyte at the upper side of the layered structure, the filling of the frame with a fluid electrolyte through an opening in the frame, as well as the closing of the opening, according to embodiments of the disclosure;

FIGS. 10a to 10d starting from the arrangement according to FIG. 7d, the arranging of a temporary closed frame for receiving a fluid electrolyte at the upper side of the layered structure, the filling of the temporary frame with a gelifying liquid electrolyte, the removing of the closed frame after the effected gelification, as well as the covering of the thus manufactured microbattery by way of a housing closure, according to embodiments of the disclosure;

FIG. 11a, 11b in a plan view, first and second current collectors of a microbattery, in a chequered arrangement and in a strip-like arrangement, according to embodiments of the disclosure;

FIG. 12a, 12b in a plan view, micro batteries, with housings of a different geometry, according to embodiments of the disclosure;

FIG. 13a, 13b the structuring of a layered structure, according to embodiments of the disclosure

FIG. 14a, 14b the joining-together of a layered structure with a plastic substrate, and the structuring of the layered structure and of the plastic substrate, according to embodiments of the disclosure.

### DETAILED DESCRIPTION

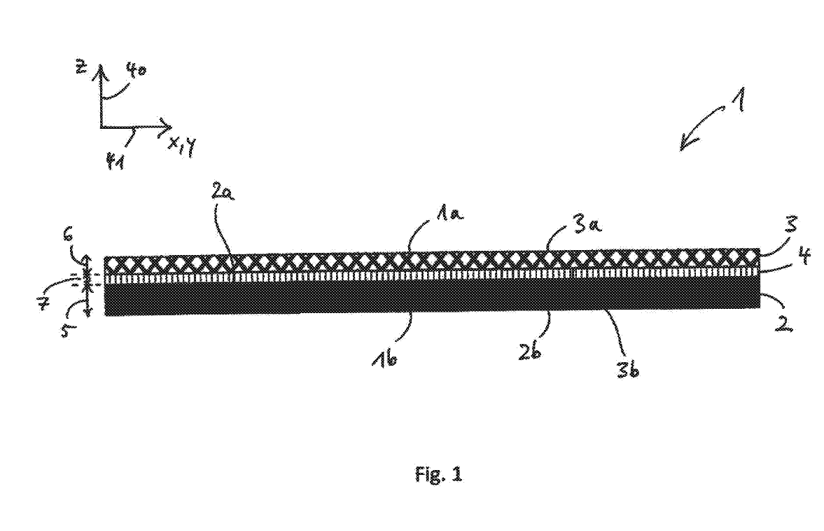

FIG. 1 shows a layered structure 1 with a first metal layer 2, with a second metal layer 3 and with an insulator layer 4 which is arranged between the first metal layer and the second metal layer. An upper side 3a of the second metal layer at the same time forms an upper side 1a of the layered structure 1. The second metal layer 3 along its lower side 3b is joined together with the insulator layer 4 and is in direct contact with this. The first metal layer 2 along its upper side 2a is joined together with the insulator layer 4 and is in direct contact with this. A lower side 2b of the first metal layer 2 at the same time forms a lower side 1b of the layered structure 1. The first metal layer 2 and the second metal layer 3 are electrically insulated from one another by way of the insulator layer 4. A Z-direction 40 runs perpendicularly to the layer planes of the layered structure 1, thus parallel to the surface normals of the metal layers 2, 3 and of the insulator layer 4. An X-Y plane 4 is directed parallel to the layer planes of the layered structure 1. The X-axis, the Y-axis and the Z-axis thereby form a right-handed Cartesian coordinate system. As to how a 3D microbattery is manufactured starting from the layered structure 1 is described hereinafter. The metal layers 2 and 3 thereby serve as current collectors of the microbattery.

In some embodiments, the first metal layer 2 is formed from aluminium. The first metal layer 2 forms the plus pole of the microbattery. The second metal layer 3 is formed from copper and forms the minus pole of the microbattery. The first metal layer 2 is an aluminium foil with a thickness 5 of 50 μm. The second metal layer 3 is a copper foil with a thickness 6 of e.g. 5 μm. The insulator layer 4 comprises a polymer, for example polypropylene or polyethylene. Here, a thickness 7 of the insulator layer 4 is 20 μm for example. The thicknesses 5, 6, 7 are determined along the Z-direction. For the manufacture of the layered structure 1, the lowers side 3b of the second metal layer 3 for example is firstly coated with the insulator layer 4, and this composite of the second metal layer 3 and the insulator layer 4 is subsequently laminated onto the upper side 2a of the first metal layer 2. The layered structure 1 can therefore be manufactured in a simple and inexpensive manner by way of known laminating or foil technologies.

Of course, in some embodiments, the metal layers 2 and 3 can also be formed from other conductive materials, in particular metals, and the insulator layer 4 of other insulating materials. Likewise, in some embodiments, the layers 2, 3 and 4 can have thicknesses which are different than the example represented in FIG. 1. The layered structure 1 can also be manufactured by methods other than by way of laminating. At least one of the metal layers 2 and 3 for example can be produced by way of sputter coating or by way of galvanic deposition. With alternative embodiments, the insulator layer 4 for example can comprise a thin glass such as Si₃N₄, SiO₂ or Al₂O₃. Such thin glass layers can have a thickness of less than 5 μm, or of less than 1 μm. The manufacture of such a thin glass layer can be carried out for example by way of reactive vapour deposition or by way of chemical vapour deposition (CVD). The layered structure 1 can also be deposited onto a substrate, for example onto a glass substrate or onto a silicon substrate, for manufacturing the microbattery. The layered structure 1 is they typically arranged with its lower side 1b on this substrate. Alternatively or additionally, a substrate can also be deposited onto the layered structure 1 or be joined together with the layered structure 1, at the upper side 1a of the layered structure 1. With regard to the substrate which is deposited onto the upper side 1a of the layered structure 1, it is then typically the case of a plastic substrate.

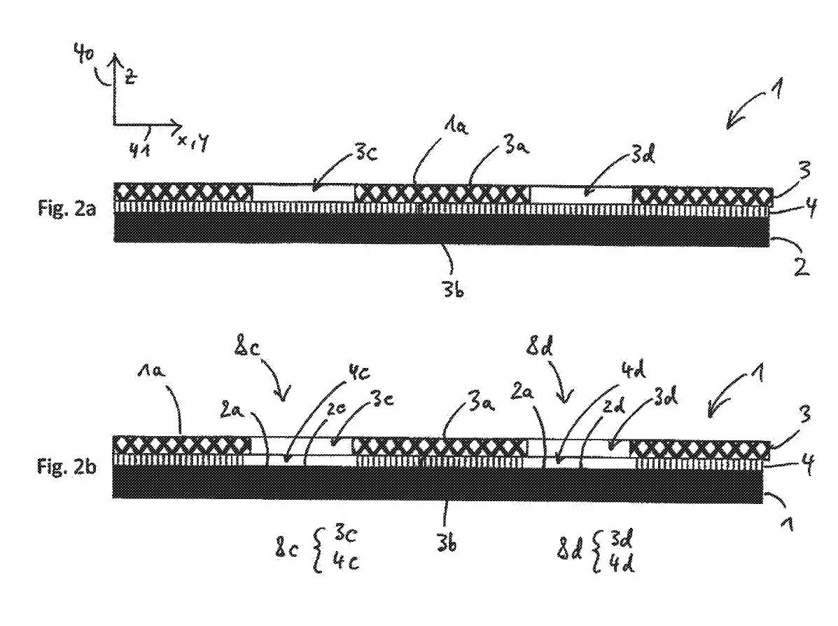

FIGS. 2a and 2b show the regional structuring of the layered structure 1 of FIG. 1 for exposing first electrode contact regions 2c and 2d of the first metal layer 2, at the upper side 2a of the first metal layer 2 which faces the insulator layer 4. Here and hereinafter, recurring features are in each case indicted with the same reference numerals. First electrodes are deposited onto the upper side 2a of the first metal layer 2, in the first electrode contact regions 2c and 2d at a later point in time.

Regions 3c and 3d are firstly removed from the second metal layer 3 for exposing the first electrode contact regions 2c and 2d. The structuring of the second metal layer 3 for removing the regions 3c and 3d from the second metal layer 3 can be carried out for example by way of wet etching, by way of laser machining or by way of mechanical machining such as drilling, milling, cutting or punching. The regions 4c and 4d of the insulator layer 4 are subsequently then removed from the insulator layer 4, for exposing the first electrode contacts 2c and 2d. This can be effected for example by way of dry-etching or, as with the structuring of the second metal layer 3, by way of laser machining or by way of mechanically machining the insulator layer 4. The regions 3c, 3d, and 4c, 4d which are aligned along the Z-direction 40 form openings 8c and 8d in the second metal layer 3 and in the insulator layer 4. The openings 8c and 8d each extend from the upper side 3a of the second metal layer 3 through the second metal layer 3 and through the insulator layer 4, up to the upper side 2a of the first metal layer 2. The first electrode contact regions 2c and 2d on the upper side 2a of the first metal layer 2 thus each form a base of the openings 8c and 8d.

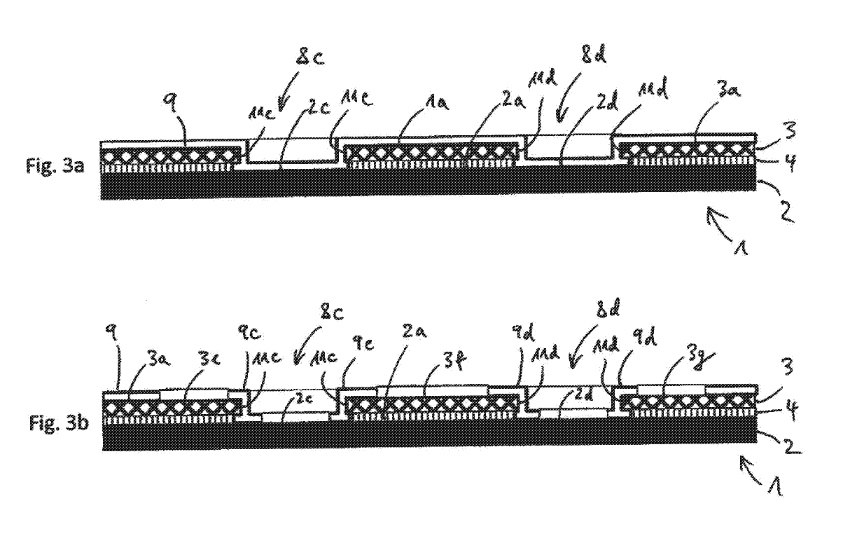

FIGS. 3a and 3b show the formation of separator structures 9c and 9d which serve for insulating first electrodes not formed on the first metal layer 2 in the first electrode contact regions 2c and 2d until a later point in time, from the second metal layer 3 for avoiding an electric short circuit, according to embodiments of the disclosure. For this, a further insulator layer 9 is firstly deposited on the upper side 1a of the layered structure 1. The further insulator layer 9 completely covers the second metal layer 3 at its upper side 3a. The further insulator layer 9 likewise completely covers the previously exposed first electrode contact regions 2c and 2d at the upper side 2a of the first metal layer 2. The further insulator layer 9 moreover completely covers sides walls 11c of the opening 8c and side walls 11d of the opening 8d, wherein the side walls 11c, 11d extend along the Z-direction 40, in each case from the upper side 2a of the first metal layer 2 up to the upper side 3a of the second metal layer 3. The further insulator layer 9 thus completely lines the openings 8c and 8d, in particular also the side walls 11c and 11d. The formation of the further insulator layer 9 can be carried out for example by way of spray coating, electrophoresis, plasma polymerisation or chemical vapour deposition CVD. A layer thickness of the further insulator layer 9 for example can be at least 0.1 μm, at least 1 μm or at least 5 μm.

The further insulator layer 9 is then regionally structured, for the renewed exposure of the first electrode contact regions 2c and 2d at the upper side 2a of the first metal layer 2 and for exposing second electrode contact regions 3e, 3f and 3g of the second metal layer 3 at the upper side 3a of the second metal layer 3. This regional structuring of the further insulator layer 9 can be effected of example by way of photolithography, by way of dry-etching or by way of laser machining.

After the regional structuring of the further insulator layer 9, this in edge regions of the openings 8c and 8d thus forms the separator structures 9c and 9d which extend continuously from the upper side 2a of the first metal layer 2 up to the upper side 3a of the second metal layer 3 and which completely line the side walls 11c and 11d of the openings 8c and 8d. The second metal layer 3 towards the openings 8c and 8d is therefore completely covered by the separator structures 9c and 9d in the regions of the openings 8c and 8d, so that the separator structures 9c and 9d prevent first electrodes which in the first electrode contact regions 2c and 2d are deposited onto the first metal layer 2 at a later point in time, from coming into contact with the second metal layer 3 and thus causing an electrical short circuit between the first metal layer 2 and the second metal layer 3.

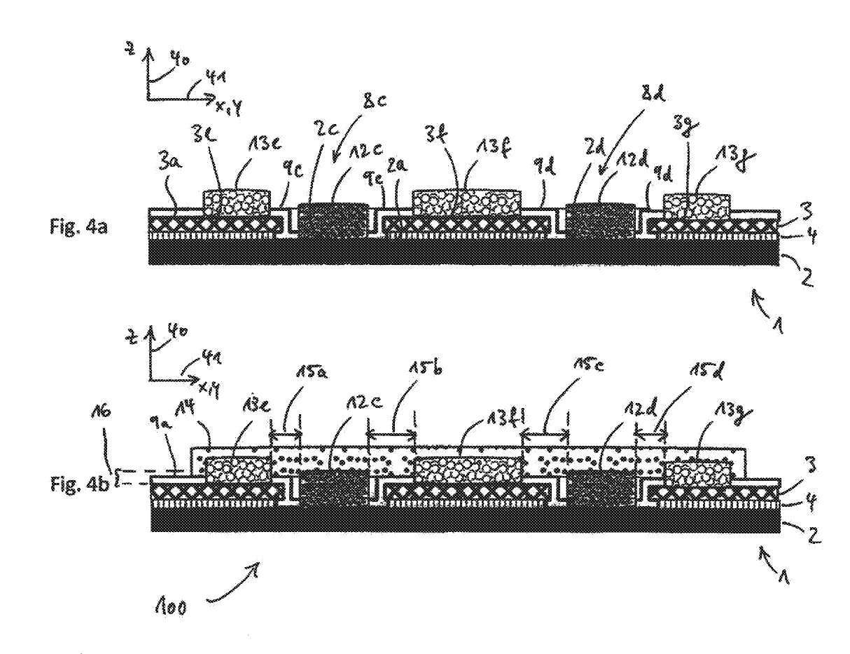

FIGS. 4a and 4b, departing from the arrangement according to FIG. 3b and in a temporal sequence show the formation of first electrodes 12c and 12d, the formation of second electrodes 13e, 13f and 13g as well as the formation of an ion conductor 14 between the first electrodes 12c, 12d and the second electrodes 13e, 13f and 13g. The arrangement according to FIG. 4b represents a microbattery 100 according to the disclosure.

The first electrodes 12c and 12d are deposited onto the first metal layer 2 in the first electrode contact regions 2c and 2d on the upper side 2a of the first metal layer 2. The formation of the first electrodes 12c and 12d can be carried out for example by way of sputtering, by way of reactive vapour deposition, by way of screen printing, by way of stencil printing or by way of a galvanic deposition process. The first electrodes 12c and 12d are designed in a manner such that they extend along the Z-direction 40 from the upper side 2a of the first metal layer 2 to above the upper side 3a of the second metal layer 3 and project beyond the upper side 3a of the second metal layer 3 perpendicularly to the layer planes of the layered structure 1. When depositing the first electrodes 12c and 12d onto the first metal layer 2, the separator structures 9c and 9d prevent the first electrodes 12c and 12d from coming into contact with the second metal layer 3 and causing a short circuit between the first metal layer 2 and the second metal layer 3. The first electrodes 12c and 12d are arranged in the openings 8c and 8d which were previously incorporated into the insulator layer 4 and into the second metal layer 3, and this arrangement is such that they engage through the insulator layer 4 and the second metal layer 3 and project beyond the upper side 1a of the layered structure 1 perpendicularly to the layer planes of the layered structure 1. The separator structures 9c and 9d in each case completely radially enclose the first electrodes 12c and 12d in a lateral manner, which is to say parallel to the X-Y plane 41, and laterally separate the first electrodes 12c and 12d from the second metal layer 3. The separator structures 9c and 9d therefore radially completely enwall the first electrodes 12c and 12d in a lateral manner, and specifically at least from the upper side 2a of the first metal layer 2 up to the upper side 3a of the second metal layer 3.

The second electrodes 13e, 13f and 13g are deposited onto the second metal layer 3, in the second electrode contact regions 3e, 3f and 3g of the second metal layer 3 at the upper side 3a of the second metal layer 3. The formation of the second electrodes 13e, 13f and 13g can also be carried out by way of sputtering, by way of reactive vapour deposition, by way of screen printing, by way of stencil printing or by way of a galvanic deposition process.

The first metal layer 2 and/or the second metal layer 3 can be pre-treated before the formation of the first electrodes 12c, 12d and the second electrodes 13e, 13f, 13g, for improving the electrical contact between the first electrodes 12c, 12d and the first metal layer 2 and/or for improving the electrical contact between the second electrodes 13e, 13f, 13g and the second metal layer 3. This pre-treatment of the first metal layer 2 and/or of the second metal layer 3 can be carried out by way of wet-etching or dry-etching for example. Alternatively or additionally, a further conductive layer, for example a polymer layer to which graphite or soot particles have been added, can be deposited onto the first metal layer 2 and/or onto the second metal layer 3, for pre-treating the first metal layer 2 and/or the second metal layer 3. The pre-treatment of the first metal layer 2 and/or the second metal layer 3 is carried out at least in the first electrode contact regions 2c, 2d of the first metal layer 2 and/or in the second electrode contact regions 3e, 3f, 3g of the second metal layer 3.

The first electrodes 12c, 12d and the second electrodes 13e, 13f, 13g are designed in a manner such that they are arranged next to one another, parallel to the X-Y plane 41, thus parallel to the layer planes of the layered structure 1. Distances 15a to 15d between the first electrodes 12c, 12d and the second electrodes 13e, 13f, 13g and which are determined parallel to the X-Y plane 41 for example can each be less than 100 μm or less than 50 μm. The first electrodes 12c, 12d and the second electrodes 13e, 13f, 13g are moreover designed in a manner such that they overlap at least regionally along the Z-direction 40. In some embodiments shown in FIG. 4, the first electrodes 12c, 12d overlap with the second electrodes 13e, 13f, 13g along the Z-direction 40, in an overlapping region 16 which departing from the upper side 3a of the second metal layer 2 extends over a length of at least 50 μm or at least 100 μm up to the upper end of the first electrodes 12c, 12d which is away from the layered structure 1.

The small distances of the first electrodes 12c, 12d from the second electrodes 13e, 13f, 13g adjacent these in each case, parallel as well as perpendicular to the layer planes of the layered structure 1 simplify the travel of ions between the first electrodes 12c, 12d and the second electrodes 13e, 13f, 13g, said electrodes being assigned in each case to the different poles of the microbattery. The travel of the ions between the first electrodes 12c, 12d and the second electrodes 13e, 13f, 13g is effected within the ion conductor 14 which is formed between the first electrodes 12c, 12d and the second electrodes 13e, 13f, 13g. The ion conductor 14 is deposited in the form of a further layer, on the upper side 1a of the layered structure 1 or on an upper side 9a of the further insulator layer 9 which covers the second metal layer 3 at least regionally. The ion conductor 14 is deposited in a manner such that it directly contacts the first electrodes 12c, 12d and the second electrode layer 13e, 13f, 13g. The ion conductor 14 forms a coherent layer. The layer which is formed by the ion conductor 14 runs parallel to the layer planes of the layered structure 1. A polymer ion conductor, a solid body ion conductor, a gelifying liquid electrolyte or a sponge-like structure impregnatable with a liquid electrolyte can be deposited for forming the ion conductor 14.

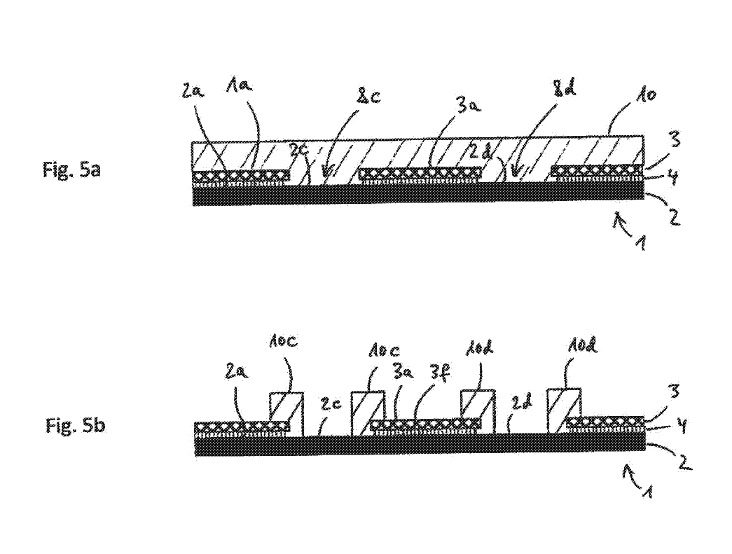

FIGS. 5a and 5b, departing from the arrangement according to FIG. 2b, show the formation of separator structures 10c and 10d in the edge regions of the openings 8c and 8d, according to embodiments of the disclosure. A temporary photoresist layer 10 is firstly deposited on the upper side 1a of the layered structure 1. The photoresist layer 10 completely covers the upper side 3a of the second metal layer 3. The first electrode contact regions 2c and 2d on the upper side 2a of the first metal layer 2 are also completely covered by the photoresist layer 10. The photoresist layer 10 is moreover deposited in a manner such that it completely fills out the openings 8c and 8d in the second metal layer 3 and in the insulator layer 4. The photoresist layer 10 is subsequently structured by way of photolithography, for forming the separator structures 10c and 10d. The first electrode contact 1 regions 2c and 2d on the upper side 2a of the first metal layer 2 as well as the second electrode contact region 3f on the upper side 3a of the second metal layer 3 are exposed by way of the structuring of the photoresist layer 10. The first metal layer 2 and the second metal layer 3 can be pre-treated as described previously with regard to FIG. 4, in particular in the first electrode contact regions 2c, 2d and the second electrode contact region 3f, for improving the electrical contactability of the first metal layer 2 and the second metal layer 3.

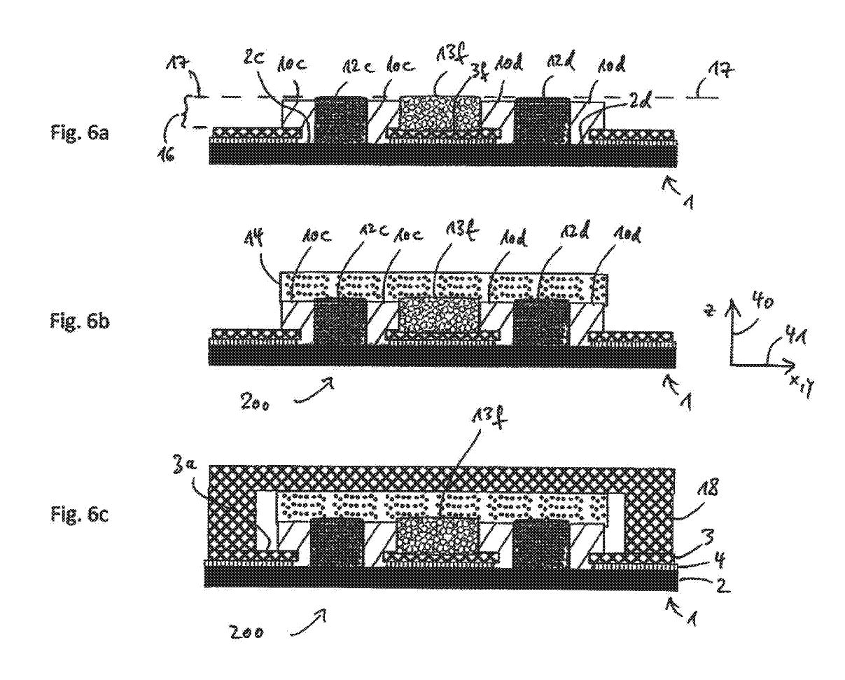

FIG. 6a shows the deposition of the first electrodes 12c, 12d in the first electrode contact regions 2c, 2d as well as the deposition of the second electrode 13f onto the second metal layer 3 in the second electrode contact region 3f. The arrangement according to FIG. 6a differs from the arrangement according to FIG. 4a in that the upper ends of the first electrodes 12c, 12d which are away from the first metal layer 2 extend along the Z-direction 40 up to the upper end of the second electrode 13f which is away from the second metal layer 3. The upper ends of the first electrodes 12c, 12d and of the second electrode 13f therefore lie in a common plane 17 which is directed parallel to the X-Y plane 41. The overlapping region 16, in which the first electrodes 12c, 12d and the second electrode 13f overlap along the Z-direction 40, in FIG. 6a therefore extends over the entire length of the second electrode 13f, specifically from the upper side 3a of the second metal layer 3 up to the plane 17.

The arrangement according to FIG. 6a further differs from the arrangement according to FIG. 4a in that the separator structures 10c, 10d extend along the Z-direction 40 in each case from the upper side 2a of the first metal layer up to the upper end of the first electrodes 12c, 12d which is way from the first metal layer 2. The separator structures 10c, 10d moreover extend along the Z-direction 40 up to the upper end of the second electrode 13f which is away from the second metal layer 3. The second electrode 13f along its entire length determined along the Z-direction 40 is therefore separated from the first electrodes 12c, 12d by the separator structures 10c, 10d. The separator structures 10c, 10d therefore completely fill out regions lying parallel to the X-Y plane 41, between the first electrodes 12c, 12d and the second electrode 13f This also prevents an electrical short-circuit between the electrodes 12c, 12d, 13f or between the first metal layer 2 and the second metal layer 3 from occurring when depositing or plating the first electrodes 12c, 12d and/or the second electrode 13f. The first electrodes 12c, 12 here are therefore completely enclosed laterally over their entire length determined perpendicularly to the layer planes of the layered structure 1, by the separator structures 10c, 10d, wherein the separator structures 10c, 10d each reach laterally directly onto the first electrodes 12c, 12d. In an analogous manner, the second electrode 13f is completely enclosed laterally over its entire length determined along the Z-direction 40, by the separator structures 10c, 10d, wherein the separator structures 10c, 10d laterally reach directly onto the second electrode 13f. This gives the arrangement of the electrodes 12c, 12d, 13f and separator structures 10c, 10d a high degree of compactness and stability.

FIG. 6b again shows the deposition of the ion conductor 14. This forms a coherent layer which is deposited or plated on the upper ends of the first electrodes 12c, 12d, of the second electrode 13f and of the separator structures 10c, 10d, said upper ends being away from the layered structure 1. The deposition or plating of the ion conductor 14 can be carried out as was previously described in the context of FIG. 4b. The arrangement according to FIG. 6b represents a microbattery 200 according to the disclosure.

FIG. 6c shows the microbattery 200 of FIG. 6b with a closure 18 which is arranged on the upper side 1a of the layered structure 1. The closure 18 closes the electrodes 12c, 12d, 13f and the ion conductor 14 laterally and to the top, which is to say in a direction away from the layered structure 1, to the surroundings. The closure 18 in FIG. 6c is formed from the same metallic material as the second metal layer 3. The closure 18 is arranged on the second metal layer 3 at the upper side 3a of the second metal layer 3 and is joined together with this second metal layer, here for example by way of soldering. The closure 18 and the second metal layer 3 are thus in electrical contact. The metallic closure 18 via the second metal layer 3 is in electrical contact with the second electrode 13f and can serve as a current collector of the second electrode 13f, due to the fact that that section of the second metal layer 3 which electrically contacts the second electrode 13f is connected to and is in electrical contact with the remaining sections of the second metal layer 3, in particular therefore with those sections of the second metal layer 3 which are in electrical contact with the closure 18.

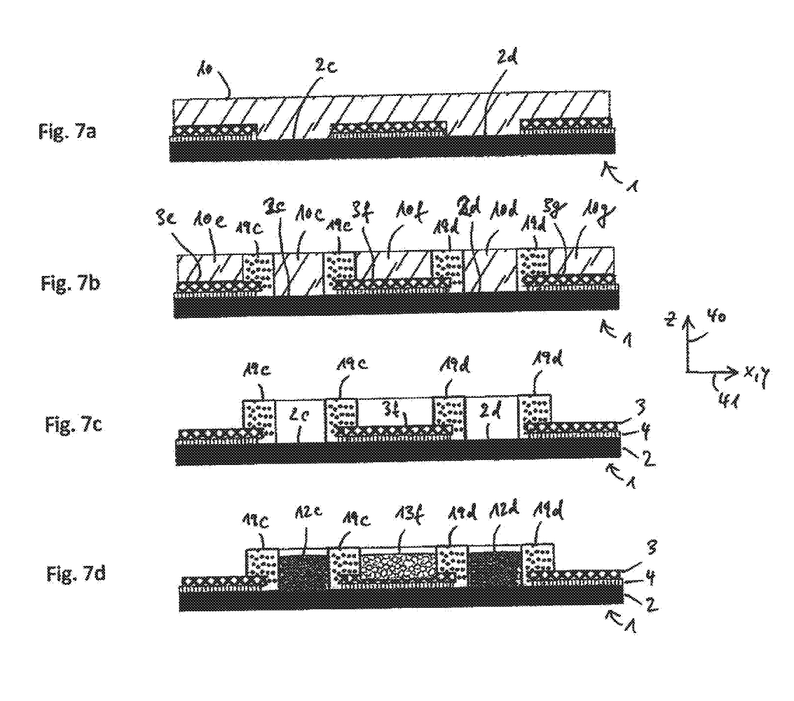

FIGS. 7a to 7d, departing from the arrangement according to FIG. 2b show the formation of separator structures 19c, 19d according to embodiments of the disclosure. The separator structures 19c, 19d according to this example are electrically insulating and ionically conductive, so that the separator structures 19c, 19d can themselves serve as ion conductors. In some embodiments therefore, the inventive formation of the separator structures 19c, 19d and the inventive formation of the ion conductor between the electrodes can be carried out in one method step.

The arrangement according to FIG. 7a corresponds to the previously described arrangement according to FIG. 5a, with the photoresist layer 10 deposited onto the layered structure 1 at the upper side 1a of the layered structure 1. The photoresist layer 10 is now structured by way of photolithography in a manner such that holes are firstly incorporated into the photoresist layer 10, where the separator structures 19c and 19d are to be formed. These holes are not represented separately in FIG. 7. Blocks 10c-g of the photoresist layer 10 remain in the region of the first electrode contact regions 2c, 2d and in the region of the second electrode contact regions 3e, 3f, 3g, after incorporating these holes into the photoresist layer 10. These blocks 10c-g with regard to the photoresist layer 10 form the negative of the separator structures 9c and 9d according to FIG. 5b.

The holes which are formed between the blocks 10c-g due to the structuring of the photoresist layer 10 are then filled with an electrically insulating and ionically conductive separator mass, for forming the separator structures 19c, 19d. The filling of the holes with the separator mass or the depositing of the separator mass in the holes, for forming the separator structures 19c, 19d can be carried out for example by way of dispensing or knife-coating. The separator mass of example can be a binding agent with ceramic particles or a binding agent with particles of ionically conductive glasses. The arrangement which is created in this manner is represented in FIG. 7b. The blocks 10c-g which have remained on structuring the photoresist layer 10 are removed in the next step, so that only the separator structures 19c, 19d formed by way of the filling of the holes between the block 10c-g with the separator mass remain, as is shown in FIG. 7c. The geometry of the separator structures 19c, 19d according to FIG. 7c is identical to the geometry of the separator structure 9c, 9d according to FIG. 5b. In some embodiments, the separator structures 19c, 19d according to FIG. 7c can also be produced directly by way of dispensing the separator mass or by way of printing the separator mass, for example by way of screen printing.

The depositing or plating of the first electrodes 12c, 12 in the first electrode contact regions 2c, 2d (see FIG. 7c) of the first metal layer 2, as well as the depositing or plating of the second electrode 13f in the second electrode contact region 3f (see FIG. 7c) of the second metal layer 3 are represented in FIG. 7d. The formation or depositing of the electrodes 12c, 12d, 13f can be carried out as described previously. The geometry of the arrangement of the electrodes 12c, 12d, 13f and of the separator structures 19c, 19d and which is represented in FIG. 7d differs from the geometry of the arrangement according to FIG. 6a only in that the separator structures 19c, 19d extend along the Z-direction 40 beyond the upper ends of the electrodes 12c, 12d, 13f which are away from the layered structure 1.

A further electrolyte layer does not necessarily have to be deposited for forming an ion conductor, as is the case for example with the arrangement according to FIG. 6b, due to the fact that the separator structures 19c, 19d according to FIG. 7d and formed by the ionically conductive separator mass permit the travel of ions via the separator structures 19c, 19d, between the first electrodes 12c, 12d and the second electrode 13f A microbattery which is manufactured according to the method steps described in FIG. 7a-d, as the case may be, can therefore have a smaller thickness and be designed in a particularly space saving manner, compared to the arrangement according to FIG. 6b.

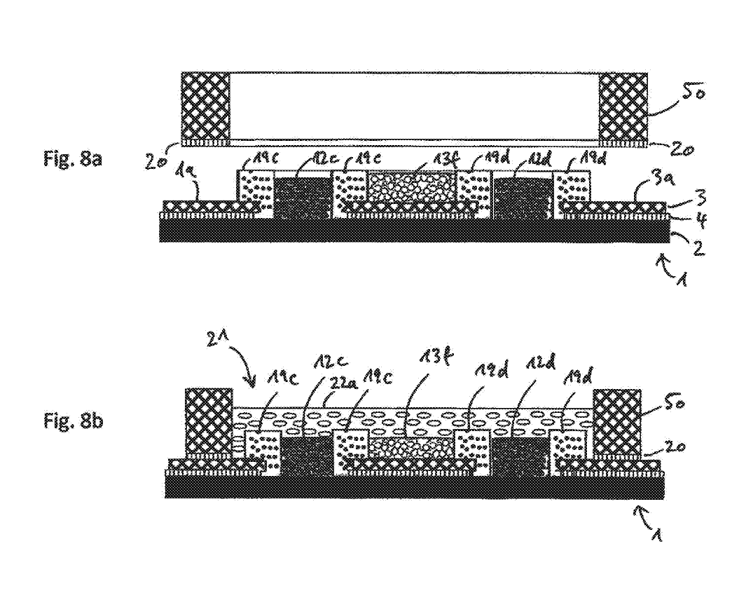

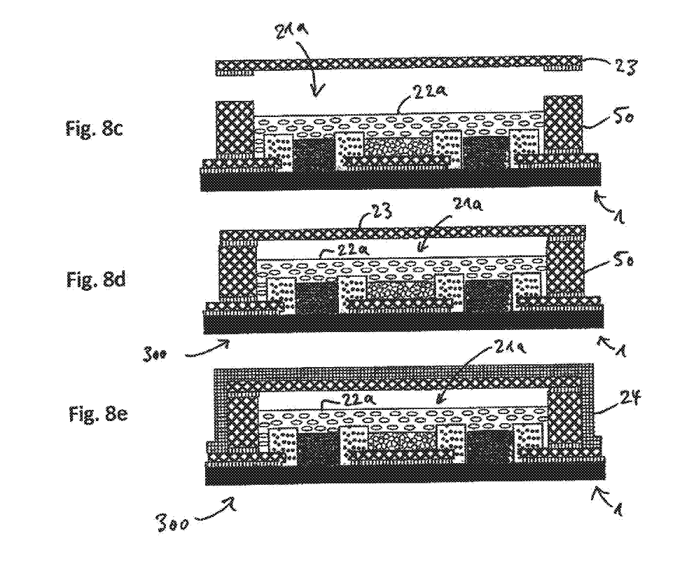

The separator structures 19c, 19d according to FIG. 7d can additionally be impregnated with a liquid electrolyte for forming the ion conductor 14. Suitable method steps are represented in the FIGS. 8a-e in a temporal sequence.

FIG. 8a shows the arrangement according to FIG. 7d, with a frame 50 for receiving a liquid electrolyte, wherein the frame 50 is arranged on the second metal layer 3 at the upper side 3a of the second metal layer 3. The fastening of the frame 50 to the second metal layer 3 can be carried out for example by way of bonding, soldering or ultrasound welding. Inasmuch as technologies with which the electrodes 12c, 12d, 13f are deposited onto an as plane as possible substrate are used for forming the electrodes 12c, 12d, 13f, it is advantageous not to join the frame 50 to the layered structure 1 until after the formation of the electrodes 12c, 12d, 13f on the upper side 1a of the layered structure 1. Technologies which necessitate an as planar as possible substrate for forming the electrodes 12c, 12d, 13f, in particular are the coating with paints and resists by way of spin coating, as well as laminating, photolithography, screen printing or the knife-coating layers. If the electrodes 12c, 12d, 13f however are formed by way of projection lithography, spray coating, coating by way of dispensers or by way of direct laser machining, then the frame, as the case may be, can already been joined together with the layered structure 1 before depositing the electrodes. With regard to the frame 50, it can be the case for example of a metal sheet which is coated with an adhesive or with a thermoplastic 20.

In FIG. 8b, the frame 50 which is arranged on the layered structure 1 encloses the electrodes 12c, 12d, 13f and the separator structures 19c, 19d, in a manner such that it forms a space 21a which is open to the top, for receiving a liquid electrolyte 22a, in which the electrodes 12c, 12d, 13f and the separator structures 19c, 19d are arranged.

The space 21a which is formed by the frame 50 is filled with liquid electrolyte 22a serving as an ion conductor, in FIGS. 8b to 8e. The frame 50 prevents the liquid electrolyte 22a from flowing away laterally. The separator structures 19c, 19d which are likewise arranged in the space 21a are impregnated with the liquid electrolyte 22a due to the at least partial filling of the space 21a with the liquid electrolyte 22a.

FIGS. 8c and 8d show the closure of the space 21a which is formed by the frame 50 and is open to the top, by way of a cover 23. The cover 23 is arranged on the frame 50 and is joined together with this, for example by way of bonding, soldering or ultrasound welding, at the upper end of the frame 50 which is away from the layered structure 1, for closing the space 21a.

In FIG. 8d, the layered structure 1, the frame 50 and the cover 23 completely close off the frame 21a filled with the liquid electrolyte 22a, to all sides, so that the liquid electrolyte 22a cannot escape from the space 21a. The arrangement according to FIG. 8d represents a microbattery 300 according to the disclosure. FIG. 8e shows the microbattery 300 of FIG. 8d which additionally comprises a barrier layer 24, with which the frame 50 and the cover 23 are sealed. The barrier layer 24 additionally prevents the exit of the liquid electrolyte 22a out of the space 21a. The barrier layer 24 can be electrically conductive, so that it contacts the second electrode 13f via the second metal layer 3 and can thus serve as a current collector for the second electrode 13f.

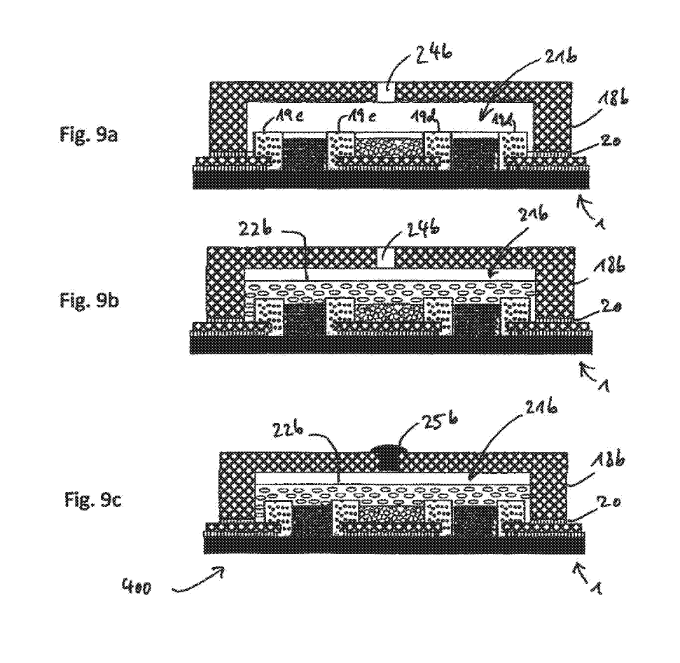

FIGS. 9a to 9c show the formation of a space 21b for receiving a liquid electrolyte 22b, the filling of the space 21b with the liquid electrolyte 22b as well as the closure of the space 21b to the surroundings, according to embodiments of the disclosure. The starting point is again the arrangement according to FIG. 7d, with which the separator structures 19c, 19d are ionically conductive. The arrangement according to FIGS. 9a to 9c differs from the arrangement according to FIG. 8d in that the space 21b is formed by a single-part housing closure 18b which for filling the space 21 with the liquid electrolyte 22b comprises an opening 24b which is closable by a closure element 25b. In FIG. 9a, the housing closure 18b is joined together with the layered structure 1 at the upper side 1a, as is shown in FIG. 8d. FIG. 9b shows the same arrangement after the filling of the space 21b with the liquid electrotype 22b through the opening 24b. FIG. 9c finally shows the arrangement of FIG. 9b, after the opening 24 in the cover 23 has been closed by the closure element 25b, so that the fluid electrolyte 22b is enclosed in the space 21b and cannot escape from the space 21b. The arrangement according to FIG. 9c represents a microbattery 400 according to the disclosure.

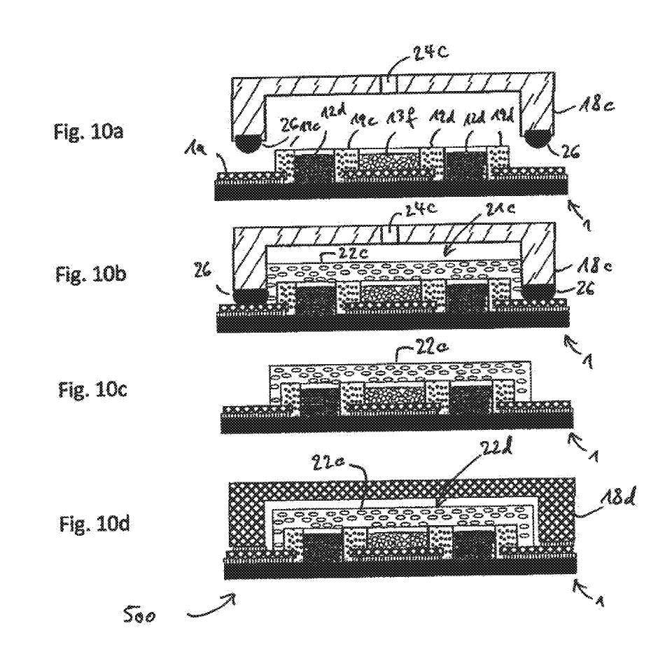

FIGS. 10a to 10d, departing from the arrangement according to FIG. 7d show the formation of a gel-like ion conductor which is formed by a gelifying liquid electrolyte 22c. In FIGS. 10a and 10b, a temporary housing closure 18c is firstly arranged on the upper side 1a of the layered structure 1, for forming a space 21c for receiving the gelifying liquid electrolyte 22c. The temporary housing closure 18c comprises elastic seals 26 on its lower side. The closure 18c with the elastic seals 26 and the layered structure 1 completely enclose the space 21c when the closure 18c is placed upon the layered structure 1 at the upper side 1a of the layered structure 1. The electrodes 12c, 12d, 13f and the separator structures 19c, 19d are then also arranged in the space 21c.

The space 21c is filled with the gelifiying liquid electrolyte 22c through an opening 24c on the upper side of the closure 18c (FIG. 10b). The elastic seals 26 thereby prevent the gelifying electrolyte 22c from flowing away out of the space 21c. The closure 18c is removed as soon as the liquid electrolyte 22c is gelified, as is represented in FIG. 10c. The now gelified electrolyte 22c forms a layer-like ion conductor which contacts the separator structures 19c, 19d. The layer-like ion conductor 22c is arranged parallel to the layers of the layered structure 1.

FIG. 10d shows a housing closure 18d which is arranged on the layered structure 1 at the upper side 1a of the layered structure 1 and which is joined together with this. The layered structure 1 and the closure 18d enclose a space 22d, in which the electrodes 12c, 12d 13f, the separator structures 19c, 19d and the ion conductor formed from the gelified electrolyte 22c are arranged. The closure 18d is formed from the same material as the second metal layer 3. The closure 18d and the second metal layer 3 can be electrically connected, so that the closure 18d can serve as a current collector for the second electrode 13f. The arrangement according to FIG. 10d represents a microbattery 500 according to the disclosure.

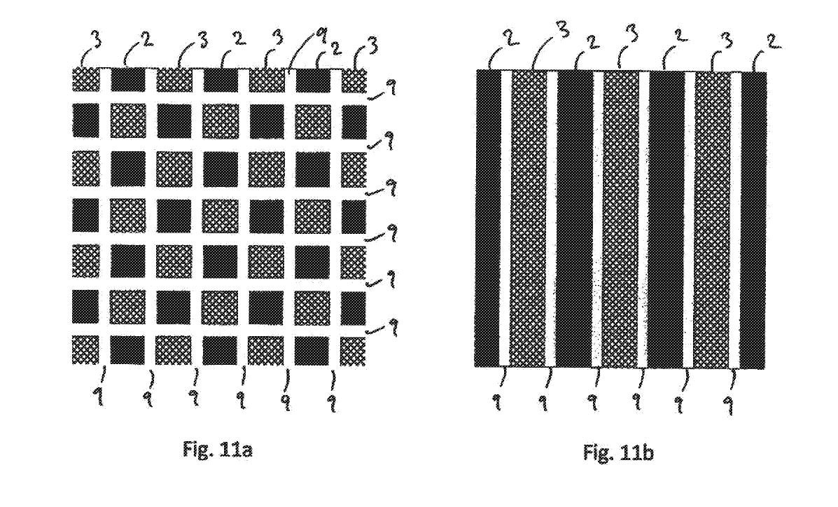

FIGS. 11a and 11b each show a plan view onto the structured metal layers 2 (black), 3 (hatched) which serve as current collectors, and onto the separator structures (white) which are arranged between the segments of the metal layers 2, 3 and which e.g. are formed from the structured further insulator layer 9 according to FIG. 3b. The viewing direction in FIGS. 11a and 11b is the negative Z-direction 40. The individual segments of the metal layers 2, 3 are arranged in a chequered manner in FIG. 11a. The individual segments of the metal layers 2, 3 are arranged in strips in the plan view of FIG. 11b. The structured current collectors which are shown in FIGS. 11a and 11b each belong to the same battery cell. The segments of the first metal layer 2 which form the current collector of the first electrodes are electrically connected to one another in the arrangements according to FIGS. 11a and 11b, and are at the same electrical potential. Likewise, the segments of the second metal layer 3 which form the current collector of the second electrodes, in the arrangements according to FIGS. 11a and 11b are electrically connected to one another below the separator structures formed by the structured further insulator layer 9, and are at the same electrical potential.

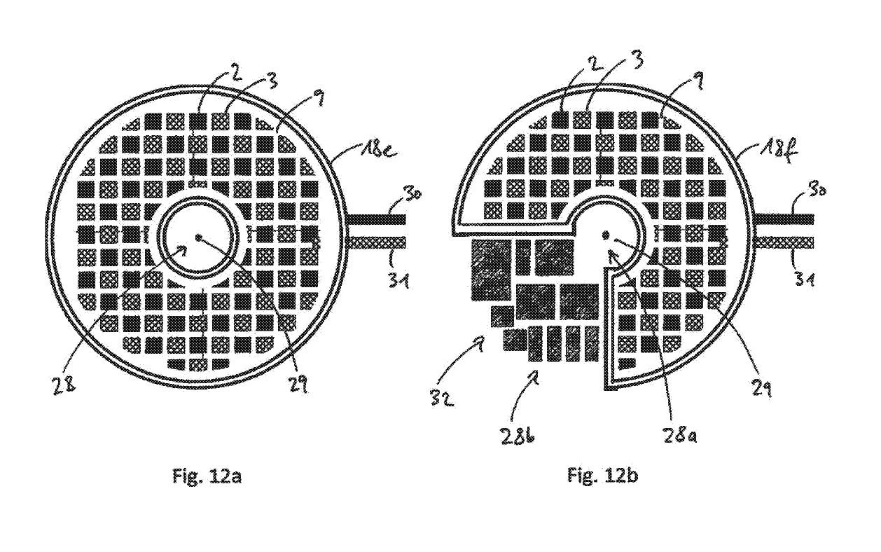

FIGS. 12a and 12b again in a plan view (viewing direction: negative Z-direction 40) show the structured metal layers 2 (black) and 3 (hatched) and the separators structures formed by the further insulator layer 9, in the chequered arrangement according to FIG. 11a, which are arranged in housings 18e and 18f of different geometries and are each adapted to these housing geometries.

FIG. 12a shows a round housing 18e with a central, round opening 28a. The round housing 18e and the central round opening 28 are arranged concentrically with respect to a common middle point 29. Current connections 30 and 31 are led to the outside through the sealed housing 18e and serve for the electrical contacting of the metal layers 2 and 3.

The housing 18f of FIG. 12b differs from the housing 18e of FIG. 12b in that the housing 18f additionally to the central opening 28a comprises a further opening 28b in the form of a coherent circle segment 28b, which here has an angle of 90°. A multitude of electronic components 32 for example is arranged in the region of the opening 28b.

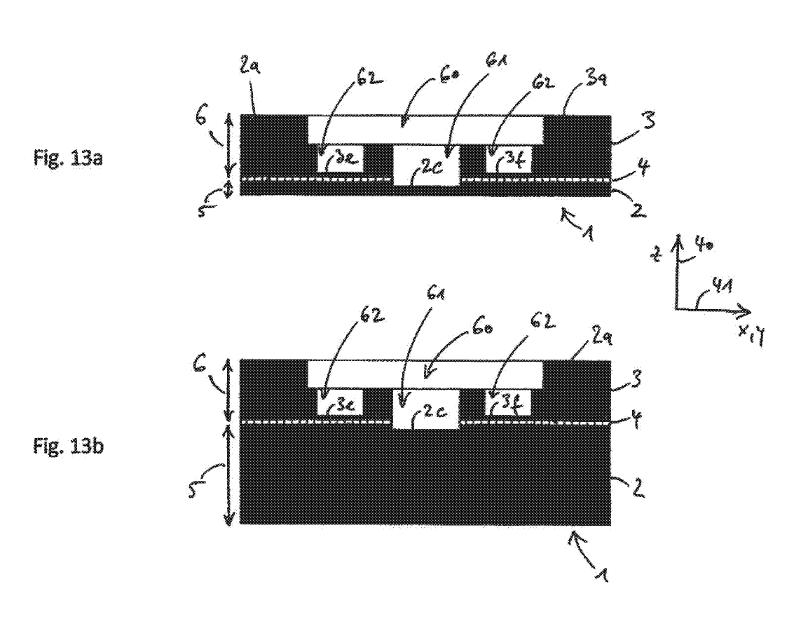

FIGS. 13a and 13b show further embodiments of the layered structure 1 shown in FIG. 2b, after the effected structuring of the second metal layer 3 and of the insulator layer 4, for exposing the first electrode contact region 2c at the upper side 2a of the first metal layer 2 and for forming the second electrode contact regions 3e and 3f of the second metal layer 3 which here are not arranged on the upper side 3a of the second metal layer 3, but in the inside of the second metal layer 3. In each case at least one of the metal layers 2, 3 has a thickness of 0.1 mm to 0.5 mm, for creating a microbattery with a particularly high mechanical stability. The thickness of the two metal layers can therefore differ e.g. by factor of at least or up to 5, of at least or up to 10 or of at least or up to 50.

In FIG. 13a, the first metal layer 2 is an aluminium foil with a thickness 5 of 5-15 μm. The second metal layer 3 is a copper foil with a thickness 6 of 100-500 μm. The first metal layer 2 was laminated onto the thicker second metal layer 3, for forming the layered structure 1. It is advantageous to deposit the layered structure on a carrier substrate (not shown here) for structuring the layered structure. The arrangement according to FIG. 13b differs from the arrangement according to FIG. 13a in that the first metal layer 2 here has a thickness 5 of 0.5-1.0 mm.

A large-surfaced deepening 60 which serves for receiving an electrolyte for forming an ion conductor is firstly incorporated on the upper side 3a of the second metal layer 3 by way of milling or by way of laser removal, for structuring the layered structure 1 according to FIGS. 13a and 13d. An opening or a channel 61 is incorporated into the second metal layer 3, into the base of the deepening 60, for exposing the first electrode contact region 2c at the upper side 2a of the first metal layer 2, in which opening or channel the first electrode is then later deposited onto the first metal layer 2. Openings or channels 62 for receiving the second electrodes are likewise incorporated into the base of the deepening 60. The base of the openings or channels 62 forms the second electrode contact regions of the second metal layer 3. The channels 61 and 62 can likewise be formed by way of milling or laser removal. The formation of the electrodes, of the separator structures and of the ion conductor can be carried out as described previously.

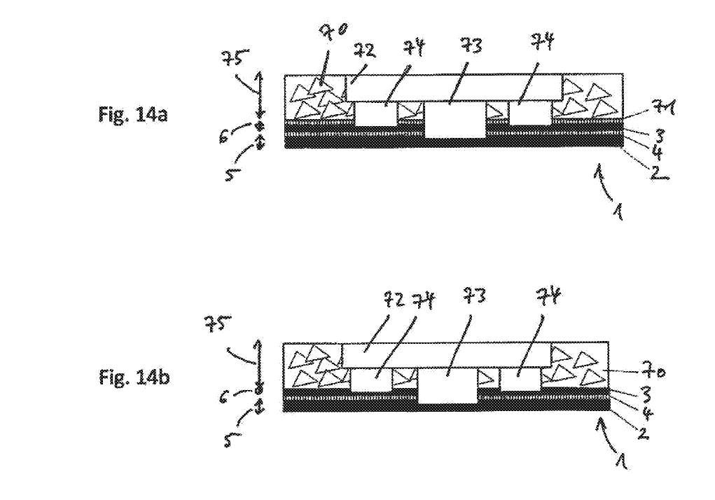

FIGS. 14a and 14b show the layered structure 1 which at its upper side is joined together with a plastic substrate 70. The thickness 5 of the first metal layer 2 and the thickness 6 of the second metal layer 3 e.g. are each less than 50 μm or less than 20 μm. With regard to the first metal layer 2, it is the case of an aluminium foil, and with regard to the second metal layer 3, of copper foil. A thickness 75 of the plastic substrate is e.g. at least 0.1 mm or at least 0.2 mm. Narrow channels with a high aspect ratio can be incorporated into the plastic substrate in a particularly simple manner, in which channels the first and the second electrodes are then deposited or plated, for contacting the first metal layer 2 and the second metal layer 3.

The arrangements according to FIGS. 14a and 14b only differ with regard to the type of joining of the layered structure 1 together with the plastic substrate 70. In FIG. 14a, both are connected by an adhesive layer 71 on the upper side of the layered structure. In FIG. 14b, the layered structure 1 and the plastic substrate 70 are connected directly to one another without such a bonding layer. This e.g. is possible if the plastic substrate 70 can be dissolved on with a solvent or melted on, for joining together with the layered structure 1.

After the joining-together of the plastic substrate 70 and the layered structure 1, a large-surfaced deepening 72 is firstly incorporated into the plastic substrate 70, preferably by way of die-casting, embossing, milling or by way of laser machining, at the upper side of the plastic substrate 70 which is away from the layered structure 1. The deepening 72 can serve for receiving an electrolyte for forming an ion conductor of the microbattery, analogously to the hole 60 in FIGS. 13a and 13b. Channels 73 and 74 for receiving the first and second electrodes are subsequently incorporated into the substrate 70, into the base of the deepening 72, and specifically firstly up to the second metal layer 3 of copper. The structuring of the plastic substrate 70 can be effected by way of laser structuring for example. The copper, second metal layer 3 can then be removed in the region of the channel 73 by way of wet-etching. The insulator layer 4 can be removed way of laser machining or by way of plasma etching, for forming the channel 73. The channels 73 and 74 can alternatively also be created by way of micro-milling. The formation of the electrodes, of the separator structures and of the ion conductor can thereafter carried out as described above.

Various modifications and additions can be made to the exemplary embodiments discussed without departing from the scope of the disclosure. For example, while the embodiments described above refer to particular features, the scope of this disclosure also includes embodiments having different combinations of features and embodiments that do not include all of the described features. Accordingly, the scope of the disclosure is intended to embrace all such alternatives, modifications, and variations as fall within the scope of the claims, together with all equivalents thereof.

1.-22. (canceled)

23. A method for manufacturing a microbattery, comprising:
forming a layered structure with a first metal layer for forming a first current collector, with a second metal layer for forming a second current collector and with an insulator layer which is arranged between the first metal layer and the second metal layer, so that the insulator layer electrically insulates the first metal layer from the second metal layer;
regionally structuring at least one of the second metal layer and the insulator layer, for exposing at least a first electrode contact region of the first metal layer on an upper side of the first metal layer which faces the insulator layer;
forming a first electrode, in a manner such that the first electrode electrically contacts the first metal layer in the exposed, first electrode contact region, and that the first electrode engages through the insulator layer and the second metal layer and projects beyond an upper side of the second metal layer which is away from the insulator layer;
forming a separator structure in a manner such that the separator structure encloses or enwalls the first electrode and extends from the upper side of the first metal layer at least up to the upper side of the second metal layer, so that the separator structure insulates the first electrode from the second metal layer;
forming at least one second electrode on the second metal layer, so that the second electrode electrically contacts the second metal layer; and
forming an ion conductor in a manner such that the ion conductor contacts the first electrode and the second electrode, so that ions can travel via the ion conductor from the first electrode to the second electrode or from the second electrode to the first electrode.

24. The method according to claim 23, wherein at least one of: regionally structuring the second metal layer for exposing the first electrode contact region of the first metal layer is carried out by way of wet-etching, laser ablation or a mechanical method including one or more of drilling, milling, cutting and punching; and regionally structuring the insulator layer for exposing the first electrode contact region of the first metal layer is carried out by way of dry-etching, laser ablation or a mechanical method including one or more of drilling, milling, cutting or punching.

25. The method according to claim 23, wherein the second metal layer is regionally coated with an adhesive or with a thermoplastic for forming the insulator layer, such that the first electrode contact region is exposed solely by the structuring of the second metal layer.

26. The method according to claim 24, wherein the second metal layer is coated over the whole surface for forming the insulator layer, so that the second metal layer and the insulator layer form a composite, wherein a through-hole is incorporated into the composite, for structuring the second metal layer and the insulator layer, and the composite with the through-hole incorporated into the composite is laminated onto the first metal layer for forming the layered structure, so that the first electrode contact region is exposed at the upper side of the first metal layer, in the region of the through-hole.

27. The method according to claim 23, wherein a further insulator layer is deposited by way of spray coating, electrophoresis, parylene plasma polymerisation, laminating or screen printing, for forming the separator structure.

28. The method according to claim 27, wherein at least one of: the further insulator layer at least regionally is deposited on the first electrode contact region of the first metal layer and wherein the further insulator layer is structured by way of photolithography, by way of dry-etching or by way of laser ablation, for the at least partial exposure of the first electrode contact region of the first metal layer; and the further insulator layer is deposited at least regionally on the second metal layer and wherein the further insulator layer is structured by way of photolithography, by way of dry-etching or by way of laser ablation, for exposing at least a second electrode contact region of the second metal layer at an upper side of the second metal layer.

29. The method according to one of the claim 23, wherein the formation of the separator structure comprises the following steps:
depositing a temporary photoresist;
regionally removing the temporary photoresist by way of photolithography, for creating a hole in the temporary photoresist; and
depositing an ionically conductive separator mass in the hole, for forming the separator structure.

30. The method according to claim 29, wherein the separator mass comprises a binder with ceramic particles and/or with particles of ionically conductive glasses.

31. The method according to claim 29, wherein the separator structure is impregnated with a liquid electrolyte for forming the ion conductor.

32. The method according to claim 23, wherein the formation of one or more of the first electrode and the second electrode is carried out by way of sputtering, reactive vapour deposition, screen printing, stencil printing, dispensing or by way of a galvanic deposition process.

33. The method according to claim 23, characterised in that one or more of the first metal layer and the second metal layer, for improving the electrical contactability, are pre-treated before the formation of the electrodes, preferably by way of wet-etching or dry-etching or by way of depositing a polymer layer to which graphite or soot particles have been added.

34. The method according to claim 23, wherein a polymer ion conductor, a solid-body ion conductor, a gelifying liquid electrolyte or a sponge-like structure impregnatable with a liquid electrolyte are deposited for forming the ion conductor.

35. The method according to claim 23, wherein a frame is arranged on the second metal layer, for receiving a liquid electrolyte, said frame preventing the liquid electrolyte from flowing away, wherein the frame is fastened on the second metal layer by way of bonding, soldering or ultrasonic welding.

36. The method according to claim 35, wherein the frame is closed off by a cover or wherein the frame and the cover are designed in a single-part manner, and the liquid electrolyte is filled through a closable opening in the cover.

37. The method according to claim 23, wherein the first electrode, the second electrode and the separator structure are designed such that the first electrode extends from the upper side of the first metal layer to beyond the upper side of the second metal layer and that the separator structure extends from the upper side of the first metal layer at least up to the upper end of the first electrode which is away from the first metal layer, preferably to beyond the upper end of the first electrode, so that the first electrode and the second electrode are separated from one another along planes running parallel to layers of the layered structure, by way of the separator structure.

38. The method according to claim 23, characterised in that the layered structure is laminated onto a plastic substrate which has a greater thickness than the layered structure.

39. A microbattery comprising:
a layered structure with a first metal layer forming a first current collector, a second metal layer forming a second current collector, and an insulator layer which is arranged between the first metal layer and the second metal layer and which electrically insulates the first metal layer from the second metal layer;
a first electrode and a second electrode;
a separator structure; and
an ion conductor which contacts the first electrode and the second electrode, so that ions can travel via the ion conductor from the first electrode to the second electrode or from the second electrode to the first electrode;
wherein the first electrode electrically contacts the first metal layer at an upper side of the first metal layer which faces the insulator layer and wherein the first electrode engages through the insulator layer and through the second metal layer and projects beyond an upper side of the second metal layer which is away from the insulator layer;
the second electrode contacts the second metal layer; and
the separator structure encloses or enwalls the first electrode and extends from the upper side of the first metal layer at least up to the upper side of the second metal layer, so that the separator structure electrically insulates the first electrode from the second metal layer.

40. The microbattery according to claim 39, wherein the first metal layer is formed from aluminium for at least one of forming and contacting the plus pole of the microbattery, and the second metal layer is formed from copper for at least one of forming and contacting the minus pole of the battery.

41. The microbattery according to claim 39, wherein the insulator layer which is arranged between the first metal layer and the second metal layer comprises one of the following materials: Si₃N₄, SiO₂, Al₂O₃, a parylene, a polyolefin, in particular polyethylene, polypropylene or cast polypropylene (CPP).

42. The microbattery according to claim 39, wherein a thickness of the layered structure is one or more of less than 1 mm, less than 0.6 mm, and less than 0.2 mm.

43. The microbattery according to claim 39, including multiple first electrodes and multiple second electrodes arranged in strips or in a chequered manner.

44. The microbattery according to claim 39, wherein the separator structure extends at least up to the upper end of the first electrode which is away from the first metal layer, so that the first electrode and the second electrode are separated from one another along planes running parallel to the planes of the layered structure, by way of the separator structure.
